(19) United States
(12) Patent Application Publication
(10) Pub. No.: US 2009/0124476 A1
(43) Pub. Date: May 14, 2009

(54) ROLLER STRUCTURE OF BUSINESS MACHINE

(76) Inventor: Yu-Lang Wu, Taipei County (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/938,654

(22) Filed: Nov. 12, 2007

(51) Int. Cl. F16C 13/00

(52) U.S. Cl. 492/57

(57) ABSTRACT

The present invention provides an improved roller structure of a business machine, having a side hole naturally formed on both distal sides of a hollow tubular roller body and provided for two sheet side covers to be coupled with the periphery of the side hole at a distal side of the roller body by friction welding, and at least one of the side covers has a ventilation hole for receiving an extended plunger to seal the cover, and a vertical protruding pivot shaft is installed at the center of another side of the two side covers (by an integral formation or a combination of separate components, such that the two pivot shafts can be extended along the direction of the shaft center of the roller body.

### FIELD OF THE INVENTION

The present invention relates to an improved roller structure of business machine, and more particularly a roller structure having the features of simple and easy installation, low cost and good structural strength.

### BACKGROUND OF THE INVENTION

Referring to FIGS. 1 and 2 for a roller structure of various traditional business machines (such as a facsimile machine and a printer, etc) or general machineries, the roller structure includes a penetrating shaft hole 52 disposed at the position of a shaft center of a roller body 5, a plurality of radiating support ribs 51 extended outward from the shaft hole 52 and pressed against the roller body 5, and a convex embedding portion 531 disposed on at least one end of the two pivot shafts 53 and corresponding to the shaft hole 52 for embedding and pressing each convex embedding portion 531 into the shaft hole 52, such that the two pivot shafts 53 can be extended outward from the shaft center position of two end portions of the roller body 5. However, the roller body 5 of such structure has the support ribs 51, and thus the roller structure is applicable for any manufacture adopting aluminum extrusion and arc turning. The production not just involves a complicated process, but also creates a sliding or loosening condition easily when the pivot shaft 53 is connected by pressing. Obviously, applications of this sort are not good enough for users.

Improvements are made as shown in FIGS. 3 and 4, wherein a side hole 11 is created separately at two end portions of a hollow roller body 1 for embedding and coupling the two side covers 4 into protrusions 42 on corresponding sides respectively, and a pivot shaft 41 is vertically extended from the center of another side of the two side covers 4, and finally the roller body 1 is coupled to the external periphery of a joint portion of the side cover 4 by welding to form a welded portion A as shown in FIG. 4. Since the welding is generally performed by laser; the equipment cost is very high, the manufacturing speed is slow; and the manufacture incurs a high production cost and is not cost-effective. In the meantime, the welded portion A is protruded separately from the surfaces of the two end portions of the roller body 1, and thus it is necessary to remove the welded portion A by cutting in a practical application. Such arrangement not just weakens the strength at the joint position only, but also produces air holes at the welded portion A easily, and the air holes are unfavorable to the later electroplating process (since electrolytes may permeate into the structure) and seriously affects the quality of the product.

In view of the shortcomings of the prior art, the inventor of the present invention based on years of experience in the related industry to conduct researches and experiments, and finally developed an improved roller structure in accordance with the present invention to overcome the aforementioned shortcomings.

### SUMMARY OF THE INVENTION

Therefore, it is a primary objective of the present invention to provide an improved roller structure of a business machine capable of effectively simplifying the manufacturing procedure, reducing the assembling time and improving production efficiency.

Another objective of the present invention is to provide an improved roller structure of a business machine with a better surface texture after going through the manufacture and a stronger structural strength of the overall assembly to effectively improve the product quality and enhance the competitiveness.

A further objective of the present invention is to provide an improved roller structure of a business machine that can reduce the investment for expensive equipment to lower the production cost.

To achieve the foregoing objectives and effects, the present invention adopts the technical measures of a roller structure comprising: a roller body; two side covers, being in a sheet form, and having pivot shaft extended vertically from the center of a side of the side cover and corresponding to the shape of the periphery at the cross-section of the roller body, and another side of the side cover is coupled separately to two end portions of the roller body by a friction welding method.

In the aforementioned structure, at least one of the two side covers has a ventilation hole for receiving an extended plunger and sealing the side cover.

In the aforementioned structure, the roller body is a hollow tube, and a side hole is naturally and separately formed on both distal surfaces of the roller body, and the two side covers are coupled to the periphery of the side holes respectively.

The above and other objects, features and advantages of the present invention will become apparent from the following detailed description taken with the accompanying drawing.

### BRIEF DESCRIPTION OF THE DRAWINGS

FIG. 1 is a perspective view of a prior art roller structure;

FIG. 2 is a section view of FIG. 1;

FIG. 3 is a perspective view of another prior art roller structure;

FIG. 4 is a section view of FIG. 3;

FIG. 5 is an exploded view of a first preferred embodiment of the present invention;

FIG. 6 is a perspective view of a first preferred embodiment of the present invention;

FIG. 7 is a section view of a first preferred embodiment of the present invention;

FIG. 8 is an exploded view of a second preferred embodiment of the present invention;

FIG. 9 is a perspective view of a second preferred embodiment of the present invention;

FIG. 10 is a section view of a second preferred embodiment of the present invention;

FIG. 11 is an exploded view of a third preferred embodiment of the present invention;

FIG. 12 is a perspective view of a third preferred embodiment of the present invention;

FIG. 13 is a section view of a third preferred embodiment of the present invention;

FIG. 14 is an exploded view of a fourth preferred embodiment of the present invention;

FIG. 15 is a perspective view of a fourth preferred embodiment of the present invention; and

FIG. 16 is a section view of a fourth preferred embodiment of the present invention.

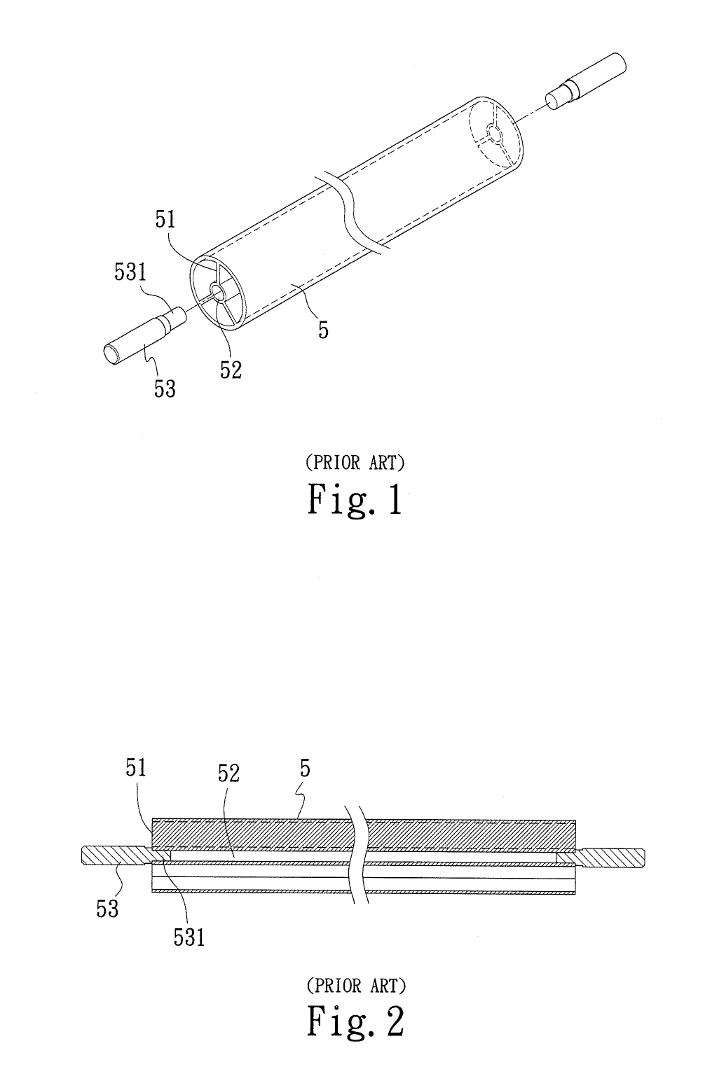

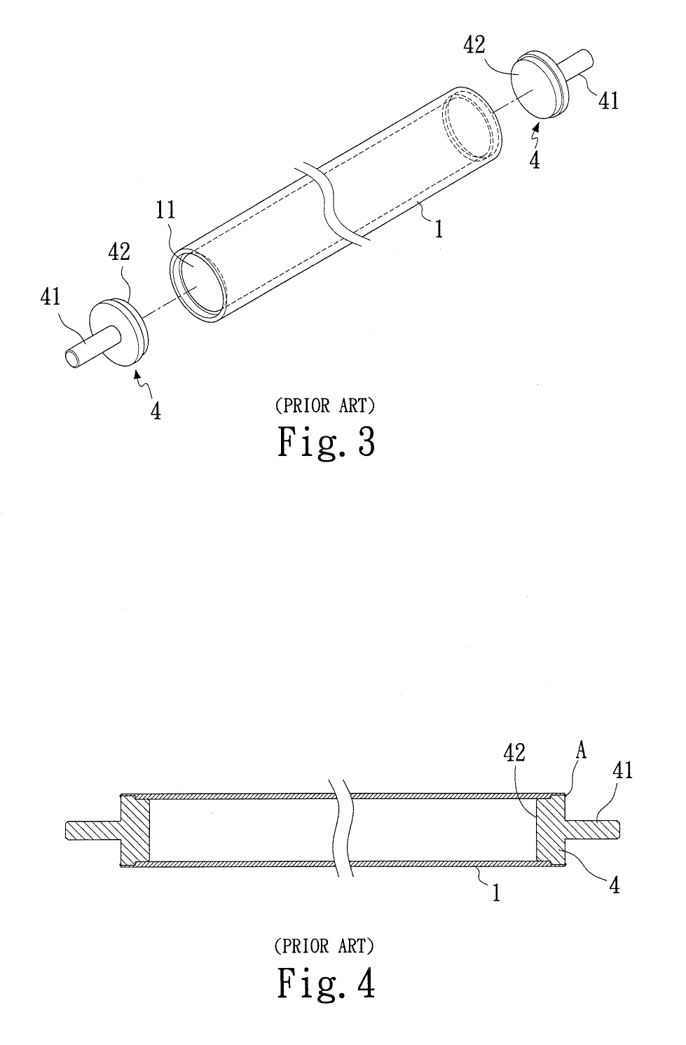

### DETAILED DESCRIPTION OF THE PREFERRED EMBODIMENTS

To make it easier for our examiner to understand the objective, innovative features and performance of the present invention, we use a preferred embodiment and the accompanying drawings for a detailed description of the present invention.

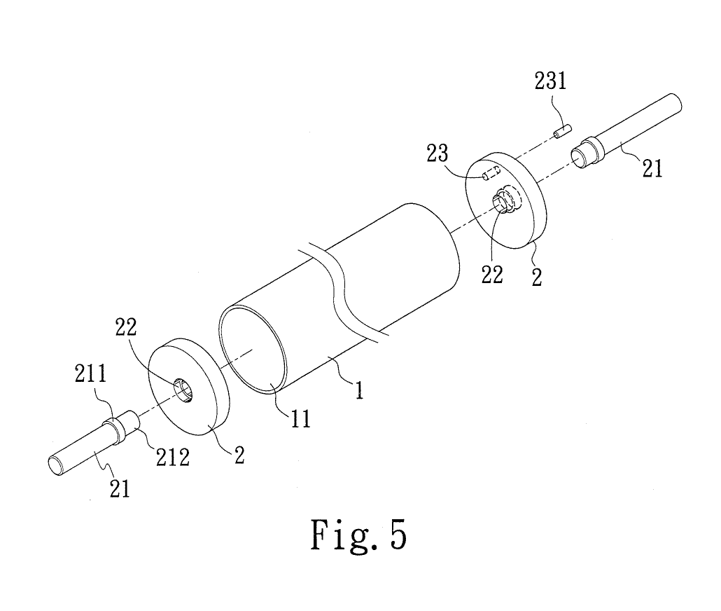

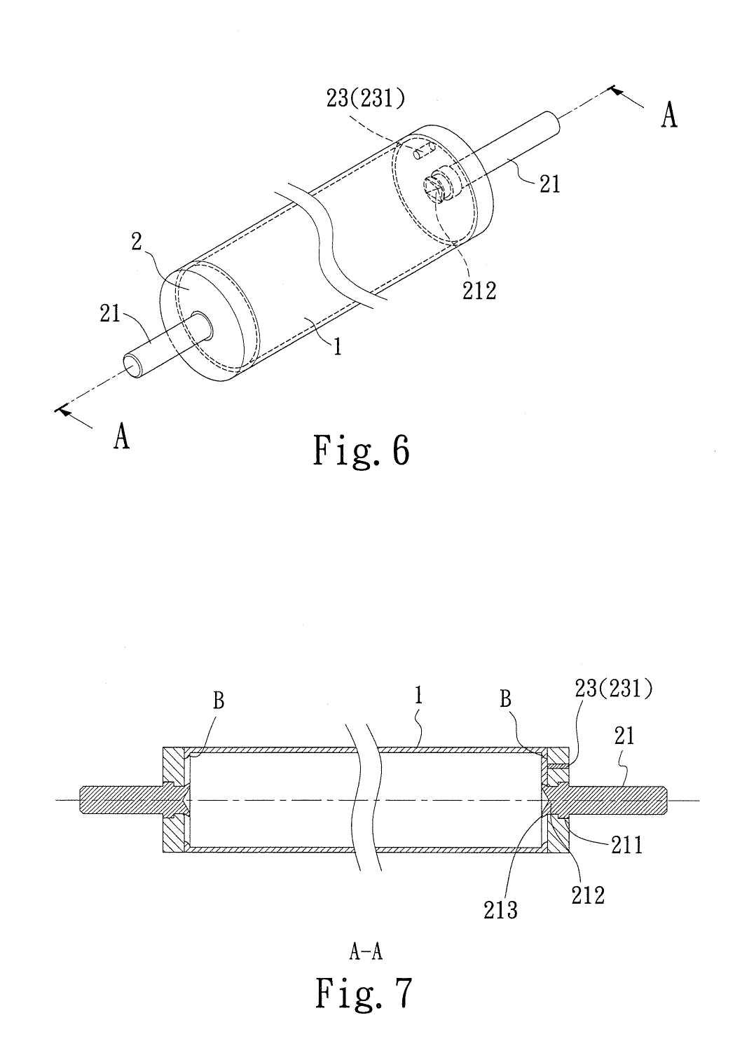

Referring to FIGS. 5 to 7 for a first preferred embodiment of the present invention, a roller structure comprises: a roller body 1 and two side covers 2, wherein the roller body 1 is a hollow circular (metal) tube with a side hole 11 naturally formed on both distal surfaces, and the side cover 2 is a circular sheet (with a shape corresponding to the cross-section of the roller body 1) and having a fish-eye shaped pivot shaft hole 22, and at least one of the side covers 2 has a ventilation hole 23 next to the pivot shaft hole 22 for receiving an extended plunger 231 to seal the side covers. Further, the two pivot shafts 21 have a convex embedding portion 212 disposed separately at an end of the pivot shaft 21, and a retenting flange 211 is disposed at the internal side of the convex embedding portion 212, such that the convex embedding portion 212 penetrates and presses on the pivot shaft hole 22, and is blocked at the pivot shaft hole 22 by the retenting flange 211, and then an external end portion of the convex embedding portion 212 is riveted to form a riveting portion 213 to secure the connection between the two pivot shafts 21 and the side cover 2, and the two side covers 2 are engaged with the periphery of the side hole 11 of the roller body 1 in an outward direction by the pivot shaft 21 to apply a pressure between the two side covers 2 and the roller body 1 and produce a high-speed rotating friction, so that the contact portion is fused (by friction welding), and the two side covers 2 are coupled to the two end portions of the roller body 1 respectively, and the pivot shaft 21 is moved outward along the shaft center. During the process of connecting the two side covers 2 to the roller body 1, the ventilation hole 23 can discharge the air inside the roller body 1, and then the plunger 231 is plugged to seal the ventilation hole 23.

In the aforementioned structure, the side cover 2 is coupled to the periphery of the side hole 11 of the roller body 1 by welding, and thus providing a better connecting strength. Even if the welding residues remained at the external periphery of the surface of the manufactured roller body 1 is removed, the welded portion B can still be formed between the two sides of the interior of the roller body 1 and the side cover 2 to assure a secured connection. Since the pivot shaft 21 and the side cover 2 are connected by a riveting structure, the roller structure of the invention has a very good connecting strength to effectively improve the torque-resistance and pull-resistance. Unlike the expensive laser welding equipments, the present invention incurs a lower equipment cost for the friction welding, and thus the present invention can meet the cost-effective requirements and lower the investment cost.

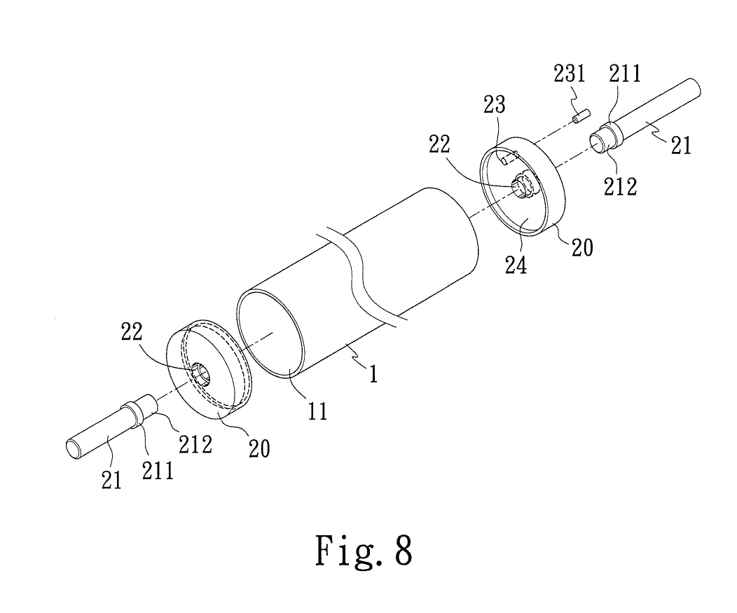

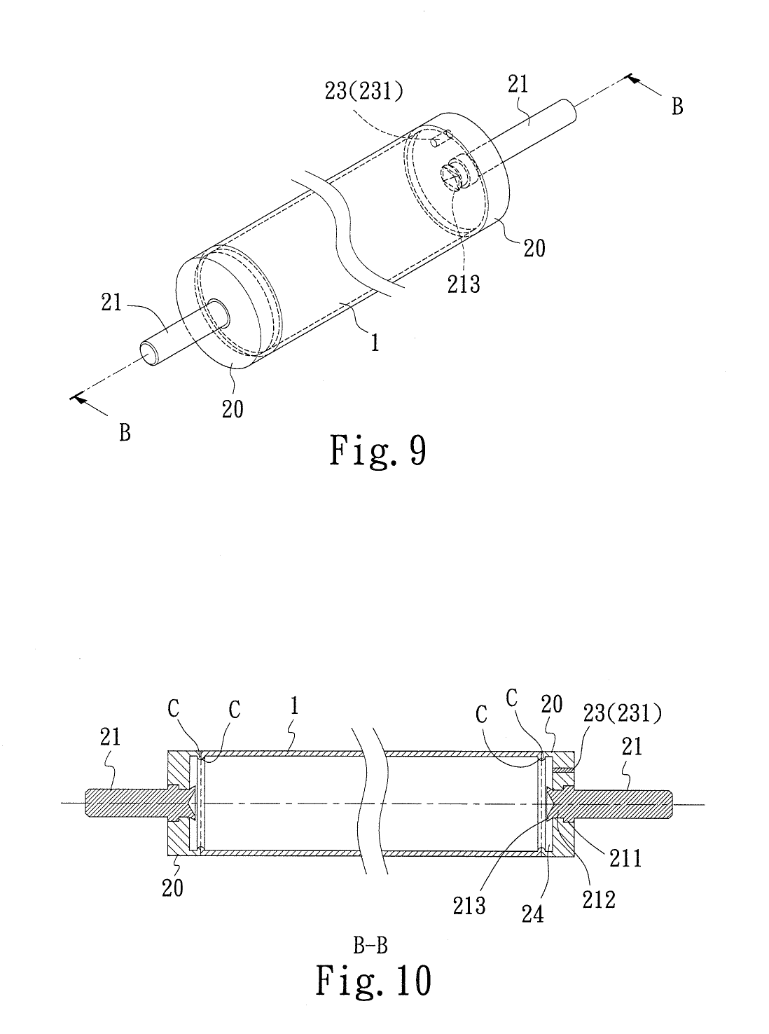

Referring to FIGS. 8 to 10 for an exploded view, a perspective view and a section view of a second preferred embodiment of the present invention, the structure of the second preferred embodiment bases on the structure of the first preferred embodiment, and the major difference of these embodiments resides on that the side cover 20 has a recession 24 disposed on the center position of another side of the pivot shaft 21, and the shape and size of the recession 24 precisely correspond to the side hole 11 of the roller body 1, such that the side cover 20 can be coupled with the periphery of the side hole 11 of the roller body 1 by the edge of the recession 24 to form a corresponding shape. After the friction welding and the surface manufacture of the roller body 1, a welded portion C is remained between both sides of the interior of the roller body 1 and the side cover 2, and the characteristics of the remaining portion of the structure of the side cover 20 are the same as those of the side cover 2, and thus will not be described here.

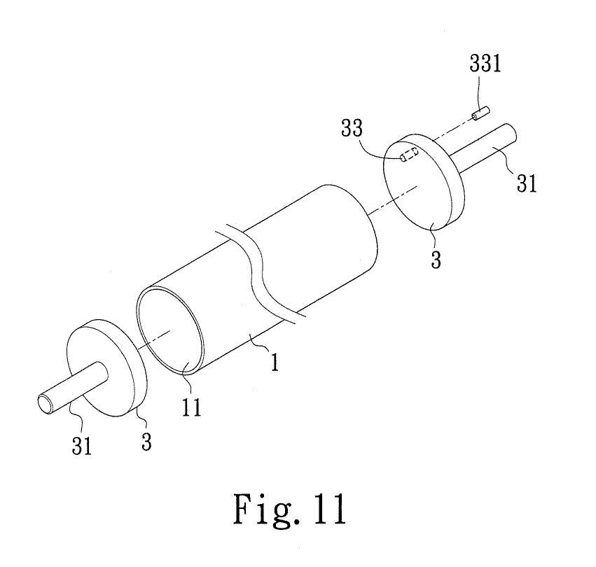

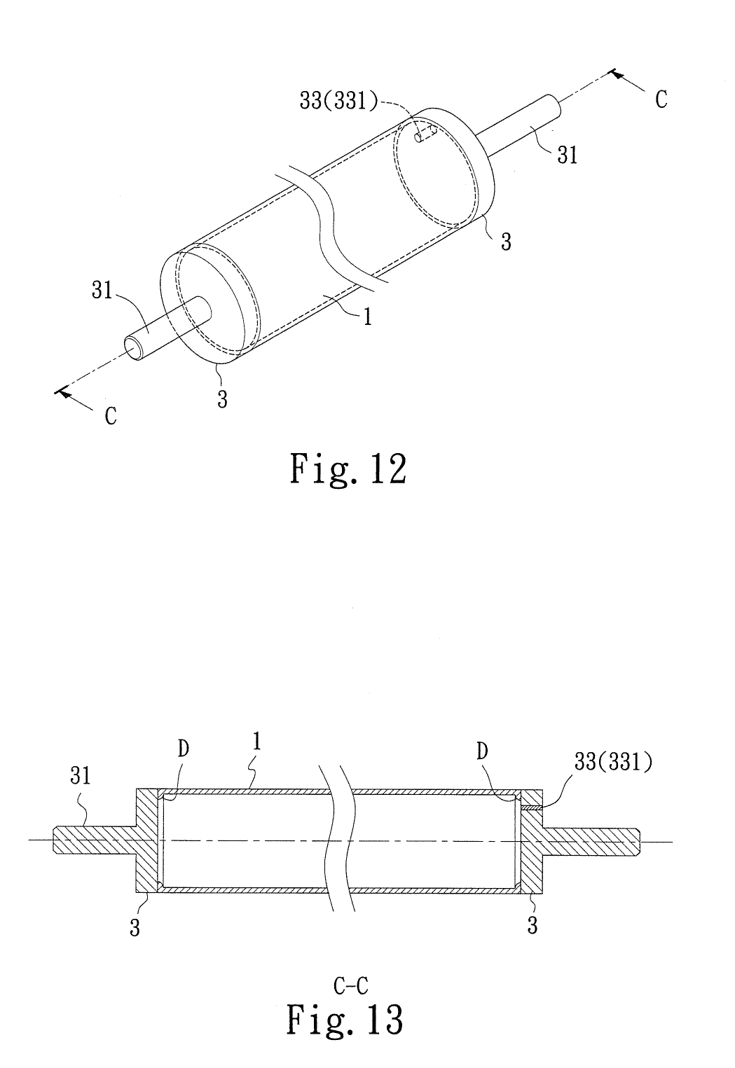

Referring to FIGS. 11 to 13 for an exploded view, a perspective view and a section view of a fourth preferred embodiment of the present invention, the characteristics of the structure of the third preferred embodiment are substantially the same as those of the structure of the first preferred embodiment, and the major difference of these embodiments resides on that the side cover 3 and pivot shaft 31 are integrally formed, and at least one of the two side covers 3 has a ventilation hole 33 for receiving an extended plunger 331 to seal the side cover 3, and the characteristics of the remaining portion of the structure of the roller body 1 and the connection with the side cover 3 are the same as those of the aforementioned embodiments. After the side cover 3 and the roller body 1 go through a friction welding and the roller body 1 goes through a surface manufacture, a welded portion D is remained between both sides of the interior of the roller body 1 and the side cover 3.

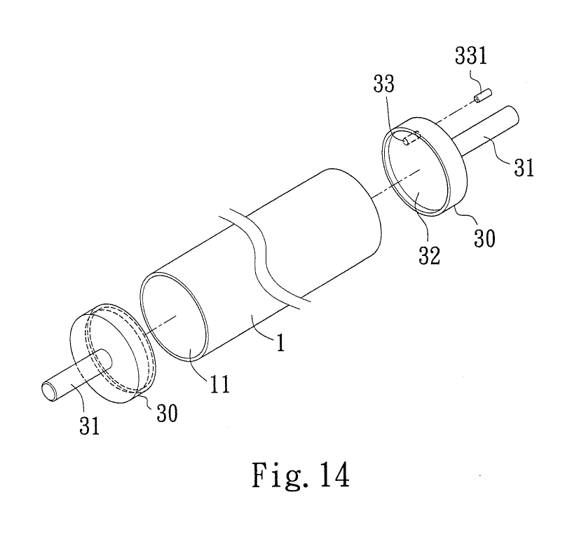

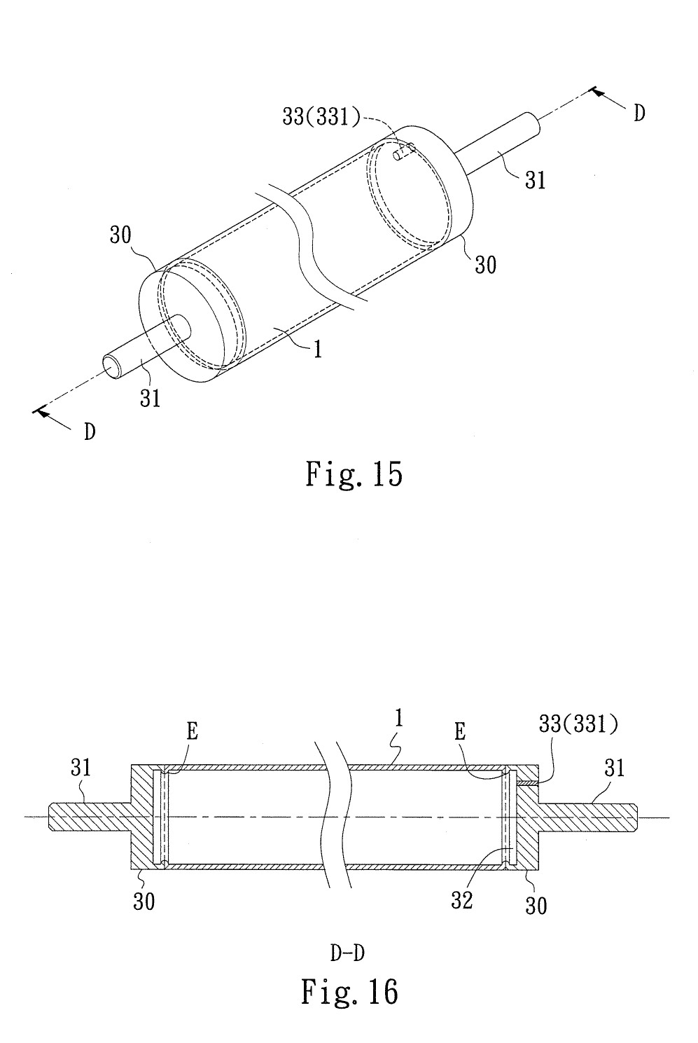

Referring to FIGS. 14 to 16 for an exploded view, a perspective view and a section view of a fourth preferred embodiment of the present invention, the structure of the fourth preferred embodiment is based on the structure of the third preferred embodiment, and the major difference of these embodiments resides on that the side cover 30 has a recession 32 disposed at the center position of another side of the pivot shaft 31, and the shape and size of the recession 32 precisely correspond to the side hole 11 of roller body 1, such that the side cover 30 can be coupled with the periphery of the side hole 11 of the roller body 1 by the edge of the recession 32 to form the corresponding shape. After the friction welding and surface manufacturing of the roller body 1, a welded portion E is remained between both sides of the interior of the roller body 1 and the side cover 30; and the characteristics of the remaining portion of the structure of the side cover 30 are the same as those of the aforementioned side cover 3.

In each aforementioned structure of the invention, the roller structure is applicable for the roller of various business machines (such as a facsimile machine, a printer, a copying machine, a scanner or a laminating machine) or a rolling shaft of general machineries, and thus the invention can be used extensively in different areas and occasions. In the meantime, the roller body 1 and the side covers 2, 20, 3, 30 (which are the welded components) can be made of the same metal or different metals selected freely from iron, stainless steel and aluminum. If the welding is performed at a larger difference of melting points of the metals (such as aluminum and iron), then it is necessary to preheat metal with a higher melting point to increase its basic temperature, such that the contact and rubbing position of the metal can be fused easily during a friction welding process.

In summation of the description above, the improved roller structure of business machine of the invention definitely achieves the effects of simplifying the manufacturing procedure, lowering the production cost, and improving the structural strength effectively, and complies with the patent application requirements, and thus the invention is duly filed for patent application.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An improved roller structure of a business machine, comprising:
a roller body; and
two side covers, being in a sheet form, and having a vertical protruding pivot shaft disposed at the center of a side of the side cover and corresponding to the shape of the periphery at the cross-section of the roller body, and another side of the side cover being coupled separately to two end portions of the roller body by a friction welding method.

2. The improved roller structure of a business machine as recited in claim 1, wherein at least one of the two side covers has a ventilation hole for receiving an extended plunger to seal the cover.

3. The improved roller structure of a business machine as recited in claim 1, wherein the roller body is a hollow tube having a side hole naturally formed on both distal surfaces, and the two side covers are coupled around the periphery of the side hole.

4. The improved roller structure of a business machine as recited in claim 2, wherein the roller body is a hollow tube having a side hole naturally formed on both distal surfaces, and the two side covers are coupled around the periphery of the side hole.

5. The improved roller structure of a business machine as recited in claim 3, wherein the side cover has a recession disposed at the center position of another side of the pivot shaft, and the recession precisely corresponds to the side hole of the roller body.

6. The improved roller structure of a business machine as recited in claim 1, wherein the side cover is coupled with a separated pivot shaft.

7. The improved roller structure of a business machine as recited in claim 2, wherein the side cover is coupled with a separated pivot shaft.

8. The improved roller structure of a business machine as recited in claim 3, wherein the side cover is coupled with a separated pivot shaft.

9. The improved roller structure of a business machine as recited in claim 4, wherein the side cover is coupled with a separated pivot shaft.

10. The improved roller structure of a business machine as recited in claim 5, wherein the pivot shaft is coupled with the side cover by a riveting method.

11. The improved roller structure of a business machine as recited in claim 6, wherein the pivot shaft is coupled with the side cover by a riveting method.

12. The improved roller structure of a business machine as recited in claim 7, wherein the pivot shaft is coupled with the side cover by a riveting method.

13. The improved roller structure of a business machine as recited in claim 1, wherein the side cover and the pivot shaft are integrally formed.

14. The improved roller structure of a business machine as recited in claim 2, wherein the side cover and the pivot shaft are integrally formed.

15. The improved roller structure of a business machine as recited in claim 3, wherein the side cover and the pivot shaft are integrally formed.

16. The improved roller structure of a business machine as recited in claim 4, wherein the side cover and the pivot shaft are integrally formed.
